(19) United States
(12) Patent Application Publication
(10) Pub. No.: US 2008/0275863 A1
(43) Pub. Date: Nov. 6, 2008

(54) SELECTING ADVERTISEMENTS BASED UPON SEARCH RESULTS

(75) Inventors: EWA DOMINOWSKA, KIRKLAND, WA (US); ROBERT J. RAGNO, KIRKLAND, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 11/744,679

(22) Filed: May 4, 2007

(51) Int. Cl. G06F 17/30

(52) U.S. Cl. 707/5; 707/E17.108

(57) ABSTRACT

Computerized methods and systems for selecting advertisements for presentation based, at least in part, upon search-result items are provided. Upon receiving a search query, search-result items (e.g., uniform resource locators (URLs)) satisfying the search query are determined. The determined search-result items are then compared with search-result criteria associated with advertisements to determine if the search-result criteria are satisfied. The determination whether or not the search-result criteria associated with an advertisement is satisfied is then utilized to determine whether the advertisement is selected for presentation in association with the search-result items. Advertisements selected for presentation may be ranked relative to one another based upon a bid amount associated therewith, with only a pre-determined number of advertisements ultimately being displayed in association with the search-result items.

### BACKGROUND

In data-searching systems preceding the Web, and on the Web since its inception, search engines have employed a variety of tools to aid in organizing and presenting advertisements in tandem with search results, which in turn optimizes the revenue received by the search engine. In addition, companies that advertise strive to develop marketing models that combine providing the most relevant exposure of their advertisement on a search engine, and ensuring that the return on advertisement investment is maximized. These marketing models utilize search engine technology to present, at a user interface, an advertisement based upon the search query submitted by a user. For instance, a search engine optimization model may involve adding material and information to the company's Webpage, and relying upon a search engine to discover the Webpage; as such, ranking it as relevant to the search query, and presenting an indicia of the Webpage at a noticeable placement on the user interface. Alternatively, a search engine marketing model may include providing an advertisement to a search engine, and supplying a maximum bid for presenting the advertisement upon the search engine receiving a particular search query. Accordingly, both models depend upon the relevance of the search query in relation to the advertisement/Webpage being displayed with the search results.

Research shows that coordinating high search relevance to the search query, i.e., providing search results relevant to an advertisement, with attaching the advertisement to those search results, will both maximize a company's return on investment when marketing online and increase advertising revenue raised by search engines. However, presently, it is difficult for an company to determine exactly which search results will returned to a user in response to a particular search query; and thus, difficult to determine the optimal revenue to attach to an advertisement. Also, a process that attaches an advertisement to a specific search result is unavailable. As such, improved advertisement discovery by utilizing search results is desirable.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to computerized methods and systems for selecting advertisements for presentation based, at least in part, upon search-result items. Upon receiving a search query, search-result items (for instance, uniform resource locators (URLs)) satisfying the search query are determined. The determined search-result items are then compared with search-result criteria associated with advertisements to determine if the search-result criteria are satisfied. Search result criteria may include, by way of example only, a particular URL an advertiser either does or does not desire to be presented in association with, ranking or position of a particular URL relative to other search-result items, and the like. The determination whether or not the search-result criteria associated with an advertisement is satisfied is then utilized to determine whether the advertisement is selected for presentation in association with the search-result items. Advertisements selected for presentation may be ranked relative to one another based upon a bid amount associated therewith, with only a pre-determined number of advertisements ultimately being displayed in association with the search-result items.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary computing system suitable for use in implementing embodiments of the present invention;

FIG. 3 is a flow diagram showing a method for selecting an advertisement for presentation based upon a received search-result item, in accordance with an embodiment of the present invention;

FIG. 4 is a flow diagram showing a method for receiving search-result criteria, in accordance with an embodiment of the present invention;

FIG. 5 is a flow diagram showing a method for determining whether a search-result item satisfies a particular search-result criteria, in accordance with an embodiment of the present invention; and

FIG. 6 is a flow diagram, in accordance with an embodiment of the present invention, showing a method for selecting advertisements for presentation and ranking the selected advertisements relative to one another.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide computerized methods and systems, and computer-readable media having computer-executable instructions embodied thereon, for selecting advertisements for presentation based, at least in part, upon the results of a search query. As utilized herein, the term “advertisement” is not meant to be limiting and may include any promotional communication between a seller offering goods or services and a prospective purchaser of such goods or services. In addition, an advertisement may contain any type or amount of data that is capable of being communicated for the purpose of generating interest in the purchase of goods or services, e.g., text animation, executable information, video, audio, and other various data forms. Any and all such variations are contemplated to be within the scope of the term “advertisement” as utilized herein.

Presentation, as contemplated by one aspect of the present invention, includes presentation at a user interface. As utilized herein, the term “user interface” is not meant to be limiting and may include any manner by which a user interacts with a particular machine, device, computer program or other complex tool (e.g., computing system). The user interface provides means of both input, allowing a user to manipulate a computing system (e.g., inputting a search query), and output, allowing the computing system to produce the effects of the user's manipulation (e.g., presenting search-result items and advertisements).

Embodiments of the present invention relate to computerized methods and systems for selecting advertisements for presentation based, at least in part, upon search-result items. Upon receiving a search query, search-result items (for instance, uniform resource locators (URLs)) satisfying the search query are determined. The determined search-result items are then compared with search-result criteria associated with advertisements to determine if the search-result criteria are satisfied. Search result criteria may include, by way of example only, a particular URL an advertiser either does or does not desire to be presented in association with, ranking or position of a particular URL relative to other search-result items, and the like. It should be understood and appreciated by those of ordinary skill in the art that search result criteria may include attributes related one or many web sites (e.g., content, URL, IP-address, title, publisher, links provided thereon, and the like), as such, these attributes are contemplated by the present invention as being inherent within the search-result items. The determination whether or not the search-result criteria associated with an advertisement is satisfied is then utilized to determine whether the advertisement is selected for presentation in association with the search-result items. Advertisements selected for presentation may be ranked relative to one another based upon a bid amount associated therewith, with only a pre-determined number of advertisements ultimately being displayed in association with the search-result items.

Accordingly, in one aspect, the present invention provides one or more computer-readable media having computer-executable instructions embodied thereon that, when executed, perform a method for selecting advertisements for presentation based upon search-result items (e.g., uniform resource locators (URLs)). The method includes receiving a search query, determining at least one search-result item that satisfies the search query, receiving a search-result criterion associated with an advertisement, and determining if the at least one search-result item satisfies the search-result criterion. The determination whether or not the search-result item satisfies the search-result criterion may then be utilized to select advertisements for presentation in association with the search-result items.

In another aspect of the present invention, a computer system is provided for selecting advertisements for presentation based upon search-result items. The computer system includes a search module, an advertisement module, and a determining module. The search module is configured to receive a search query and to determine one or more search-result items (e.g., URLs) that satisfy the received search query. The advertisement module is configured to receive one or more search-result criterion (e.g., URLs with which an advertiser does or does not desire to be associated, position of a URL with respect to other search-result items, etc.), each search-result criterion having an advertisement associated therewith, and configured to receive a bid amount associated with each advertisement. The determining module is configured to determine if one or more received search-result items satisfies at least one of the one or more received search-result criterion. The computer system may further include one or more of a search-result ranking module configured to rank a plurality of received search-result items with respect to one another based upon relevance to the received search query, a selection module configured to select or exclude advertisements associated with the one or more search-result criterion for presentation based upon whether the one or more search-result items that satisfy the received search query are determined to satisfy at least one of the one or more search-result criterion, an advertisement ranking module configured to rank a plurality of selected advertisements with respect to one another based upon the bid amount associated therewith, and a presentation module configured to present selected advertisements.

In another aspect, the present invention provides a computerized method for associating advertisements with search result criteria. The method includes receiving an advertisement; receiving at least one search-result criterion, the at least one search-result criterion providing a characteristic to be satisfied by a search-result item (e.g., a URL) before the search-result item is selected for or excluded from presentation in response to a search query; and storing the advertisement and the at least one search-result criterion in association with one another.

Having briefly described an overview of embodiments of the present invention, an exemplary operating environment suitable for implementing the present invention is described below.

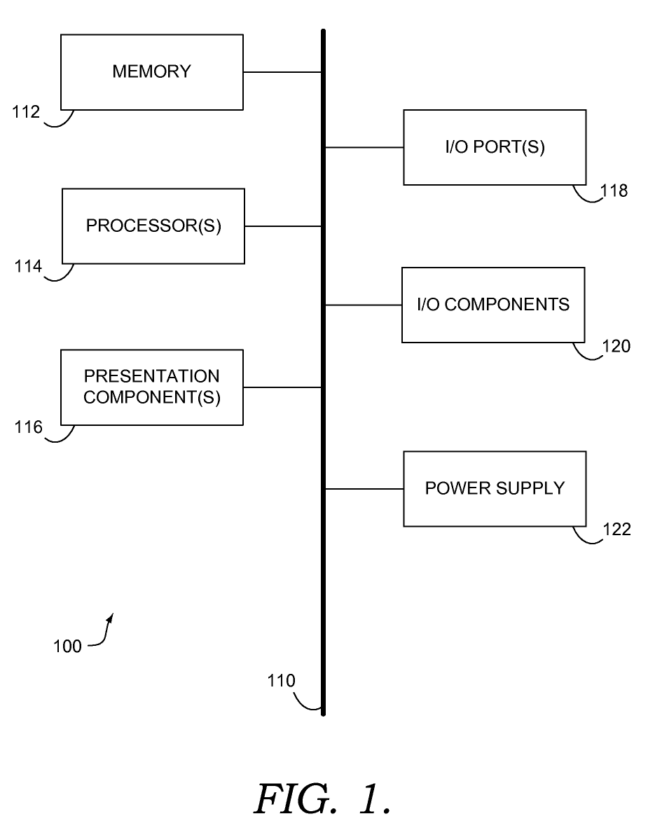

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of components/modules illustrated.

The invention may be described in the general context of computer code or machine-usable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. Embodiments of the present invention may be practiced in a variety of system configurations, including hand-held devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVDs) or other optical or holographic media; magnetic cassettes, magnetic tape, magnetic disk storage or other magnetic storage devices, or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game pad, satellite dish, scanner, printer, wireless device, etc.

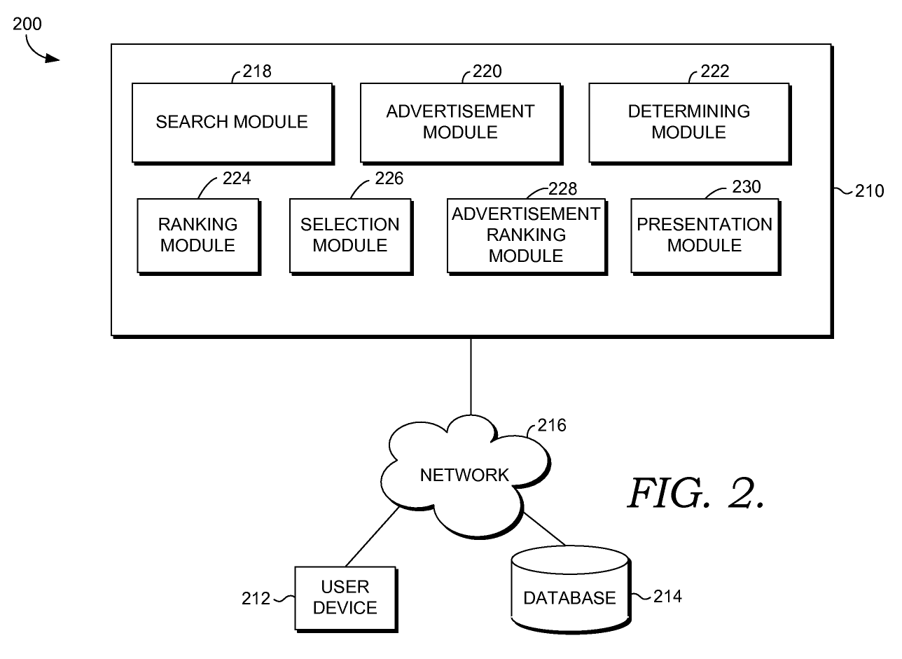

Turning now to FIG. 2, a block diagram is illustrated, in accordance with an embodiment of the present invention, that shows an exemplary computing system 200 configured to select advertisements for presentation based, at least in part, upon search-result items identified in response to a search query. It will be understood and appreciated by those of ordinary skill in the art that the computing system 200 shown in FIG. 2 is merely an example of one suitable computing system environment and is not intended to suggest any limitation as to the scope of use or functionality of embodiments of the present invention. Neither should the computing system 200 be interpreted as having any dependency or requirement related to any single component/module or combination of components/modules illustrated therein.

The computing system 200 includes a server 210, a user device 212, and a database 214, all in communication with one another via a network 216. The network 216 may include, without limitation, one or more local area networks (LANs) and/or wide area networks (WANs). Such networking environments are commonplace in offices, enterprise-wide computer networks, intranets, and the Internet. Accordingly, the network 216 is not further described herein.

The database 214 may be configured to store information associated with search-result items, search-result criteria, advertisements, ranking algorithms, bid parameters, and the like. In addition, embodiments of the present invention consider components having zero items associated therewith such that an organizational blueprint with an empty set is retained. In some embodiments, the database 214 is configured to be searchable for one or more of the items stored in association therewith. It will be understood and appreciated by those of ordinary skill in the art that the information stored in the database 214 may be configurable and may include any information relevant to search queries, search-result criteria, advertisements, and the like. Further, though illustrated as a single, independent component, database 214 may, in fact, be a plurality of databases, for instance, a database cluster, portions of which may reside on a computing device associated with the server 210, the user device 212, another external computing device (not shown), and/or any combination thereof.

Each of the server 210 and the user device 212 shown in FIG. 2 may be any type of computing device, such as, for example, computing device 100 described above with reference to FIG. 1. By way of example only and not limitation, the server 210 and/or the user device 212 may be a personal computer, desktop computer, laptop computer, handheld device, mobile handset, consumer electronic device, and the like. It should be noted, however, that the present invention is not limited to implementation on such computing devices, but may be implemented on any of a variety of different types of computing devices within the scope of embodiments hereof.

As shown in FIG. 2, the server 210 includes a search module 218, an advertisement module 220, a determining module 222, a ranking module 224, a selection module 226, an advertisement ranking module 228, and a presentation module 230. In some embodiments, one or more of the illustrated modules 218, 220, 222, 224, 226, 228, and 230 may be implemented as stand-alone applications. In other embodiments, one or more of the illustrated modules 218, 220, 222, 224, 226, 228, and 230 may be integrated directly into the operating system of the server 210 or the user device 212. By way of example only, the search module 218 may be housed in association with the database 214, while the presentation module 230 may be housed in association with the user device 212. In the instance of multiple servers, the present invention contemplates providing a load balancer to federate incoming queries to the servers. It will be understood by those of ordinary skill in the art that the modules 218, 220, 222, 224, 226, 228, and 230 illustrated in FIG. 2 are exemplary in nature and in number and should not be construed as limiting. Any number of modules may be employed to achieve the desired functionality within the scope of embodiments of the present invention.

The search module 218 is configured to receive a search query and to determine one or more search-result items that satisfies the received search query. The term “search-result item” is not meant to be limiting, and may include, by way of example only, a file, a document, a uniform resource locator (URL)-addressable Webpage, or other information that is discoverable upon executing a search of information accessible by the computing system 200. Typically, a search is carried out by a search engine, wherein a search engine is an information retrieval system designed to locate information in response to a search query received from a user. The term “search engine” is not meant to limiting and is utilized herein to indicate a component or system having search functionality, and may be included within any one or more of the modules/components associated with the computing system 200.

By way of example only, a user may input a search query at a user interface associated with a display device. It will be understood and appreciated by those of ordinary skill in the art that multiple methods exist by which a user may input the search query into the search module 218. For instance, user-defined queries may be input, by way of example only, utilizing a keyboard, joystick, trackball, touch-pad, or the like. In one embodiment, a user is provided a Web browser as the user interface display in which the user may input the search query into an associated query-receiving area. Alternative user interfaces known to those of ordinary skill in the art are contemplated to be included within embodiments of the invention.

Upon receiving a search query, it is determined whether any search-result items accessible via the search module 218 satisfy the search query. Such determining may include consulting one or more indices for matching items-utilizing the received search query and at least one other criteria provided by the user (as more fully described below)—and providing a list of matching search-result items. In embodiments, the list of matching search-result items may include a short summary containing a descriptive title and/or a portion of the content associated with the search-result item.

The advertisement module 220 is configured to receive one or more search-result criterion, each search-result criterion having an advertisement associated therewith. Search-result criteria may include, by way of example only, a URL with which an advertiser desires the associated advertisement to be presented in proximity thereto, a URL that an advertiser desires the associated advertisement to be excluded from presentation in proximity thereto, a position or ranking of a URL relative to other search-result items satisfying the search query, and the like. That is, generally, search-result criteria are received from advertisers to incrementally or exclusively target advertisements for presentation in response to a search query. It will be understood and appreciated by those of ordinary skill in the art that the term “advertisers,” as utilized herein, is not meant to be limiting and may include, by way of example only, entities (e.g., persons, companies, any type of grouping), software (e.g., marketing applications, actions performed by the computing system 200), or the like.

Advertisers may select search-result criteria from a pre-defined list, menu, table, or the like (e.g., where available options have been binned for efficiency), or by entering text in a text area provided on a user interface (e.g., where the advertiser has been provided full control in selecting search-result criteria). Typically, the type of search-result criteria that is selected from pre-defined criteria is a category, whereas URLs and keywords are types of search criteria that may be typically entered as text.

In one embodiment, a search-result criterion may include a URL that references a URL-addressable Webpage. In this embodiment, the URL is supplied by an advertiser, e.g., as part of an advertising campaign, so that if the URL is satisfied (discussed below), the advertisement is selected for presentation in association with the URL along with the search-result items. Being associated with a search-result criterion may include linking one or more search-result criteria with one of more advertisements so that if the search-result criteria is satisfied, a link to the advertisement that the advertiser had intended for presentation in such circumstances may be followed.

By way of example only, a URL supplied by an advertiser may be synchronized with search-result items related to the same advertiser, or may be competitively synchronized. For instance, an advertiser may elect to synchronize an advertisement by supplying its own URL as the search-result criteria in an effort to have its own advertisement selected for presentation whenever its own URL is determined as a search-result item in response to a search query. Alternatively, the same hypothetical advertiser may elect to advertise competitively by providing a search-result criteria specifying a desire to have a submitted advertisement selected for presentation when a competitor's URL is among the determined search-result items.

In another embodiment, a received search-result criterion may include a category pertaining to a shared characteristic of a plurality of search-result items. In this embodiment, a category is typically selected from a list of pre-defined categories associated with the advertisement module 220. As applied, if the category is satisfied (discussed below) by the search-result items, then the advertisement associated with the category is selected for presentation on a user interface in association with the search-result items. This type of search-result criteria tends to offer broad-range search-result criteria that is satisfied by a larger scope of search-result items when compared against a specific URL, as more fully discussed above.

By way of example only, a category supplied by an advertiser may be “automobiles.” In this instance, the category may be pre-defined as comprising a one or more URLs relevant to the category subject matter, e.g., pre-defined criteria, or may be amended/supplanted by URLs offered by the advertiser. If the search-result items include the pre-defined or presently defined URL as being within the “automobiles” category, the search-result criterion will be determined to have been satisfied and the associated advertisement is selected for presentation in association with the search-result items.

In another embodiment, a search-result criterion may include a keyword that corresponds with the information included within the search-result items. In this embodiment, the keyword is typically supplied by the advertiser and provided as text in a text area associated with a user interface. As applied, the keyword is satisfied by comparing the keyword, or a semantic transformation thereof, to the information included in the search-result items, e.g., text within a document. Upon determination that the keyword and information correspond, the search-result item having the corresponding information is determined to have satisfied the search-result criterion, and the advertisement associated with the keyword is selected for presentation in association with the search-result items.

An advertiser may elect to optionally submit positional criteria when submitting a search-result criterion. Positional criteria pertains to an ordering of the position of search-result items in a presentation of the at least one search-result item. If positional criteria is submitted, the consideration for presentation of the advertisement is reliant upon a determination that the positional criterion is satisfied, and not just that the search-result criterion associated therewith is satisfied. Determining that the positional criteria is satisfied may comprise comparing the algorithmic ordering with the positional criteria.

By way of example only, an advertiser might elect to submit positional criteria requiring that the search-result items that satisfy the search-result criteria must be within the top twenty positions when presented to the user interface display. When applied to the process of determination of which advertisements to present, the following outcomes may occur. If the search-result criteria is satisfied by a search-result item within the top twenty positions, as indicated by the algorithmic ordering associated therewith, then the advertisement is considered for presentation at the user interface. If, however, the search-result criteria is satisfied by a search-result criteria that is not in the top twenty positions, i.e., not meeting the positional criteria, then the advertisement is not considered for presentation.

In addition to the search-result criteria and associated advertisements, presentation characteristics associated with the advertisements may be received. One such presentation characteristic allows the advertiser to provide a preferable location on the user interface where the advertisement will be presented. Others may include size, format, and layout of the advertisement or the test attached thereto. Although several embodiments of the advertisement and the associated presentation characteristics have been described, it will be understood and appreciated by those of ordinary skill in the art that other configurations for submitting and presenting the advertisement may be utilized, and that the invention is not limited to those embodiments described.

The advertisement module 220 is further configured to receive a bid amount associated with each advertisement received. Generally, as the system 200 is being utilized to select advertisements for presentation, a cost-per-impression for the advertisement will be received. However, it will be understood by those of ordinary skill in the art that any revenue model may be utilized for providing bids on advertisements. In embodiments, the bid amount may be exclusive or may include an incremental component; that is, an additional amount the advertiser is willing to pay if a particular incremental criterion is satisfied. Any and all such variations, and any combination thereof, are contemplated to be within the scope of embodiments of the present invention.

The determining module 222 is configured to determine if one or more received search result items (e.g., received by search module 218) satisfies at least one of the one or more received search-result criterion (e.g., received by advertisement module 220). If more than one search-result item is determined to satisfy the received search-result criteria, the ranking module 224 may be utilized to rank each of the plurality of search-result items relative to one another. In one embodiment, the ranking module 224 is configured to apply an algorithmic search ranking to the determined search-result items, thereby establishing an algorithmic ordering of search-result items within a list of search-result items returned in response to a search query. Typically, the algorithmic ordering relates to the presentation order of the search-result items in association with the user interface (as more fully described below). In one instance, the algorithmic search ranking sets the algorithmic ordering by determining the relevance of each search-result item to the search query, e.g., a highly relevant search-result item may be placed closer to the top of a vertical listing of search-result items. However, those of ordinary skill in the art will understand and appreciate that other methods for ranking or determining algorithmic ordering of the search-result items may be applied, and any and all such methods are contemplated to be within the scope of embodiments the present invention.

The selection module 226 is configured to select or exclude advertisements associated with one or more search-result criterion for presentation based upon whether the search-result items satisfying a search query are determined to satisfy the search-result criterion. Determining whether the search-result item corresponds to the search result criterion may include comparing the one or more search-result items with at least one type of search-result criteria associated with an advertisement. In one embodiment, where the search-result criteria is a URL, a URL search-result item having a corresponding URL-addressable Webpage will be determined to satisfy that search-result criteria and the advertisement associated therewith will be selected for presentation.

The advertisement ranking module 228 is configured to rank a plurality of selected advertisements with respect to one another based upon the bid amount (and any incremental adjustment) associated therewith. Ranking the advertisement is typically comprised of receiving advertisements selected for presentation and providing an order to received advertisements according to the bid amount associated therewith. In one embodiment, providing an order involves highly-ranking those advertisements having a revenue module (e.g., CPC, CPA), which will provide the greatest return per click or action. In addition to ranking the selected advertisements, one aspect of the present invention is that the advertisement ranking module 228 may determine how many of the selected advertisements may be passed to the presentation module 230 for presentation, e.g., at a user interface associated with the user device 212. This determination may be based on a pre-selected number, the size of the advertisements initially selected by the advertisement ranking module 228 in comparison with the space provided by presentation medium, or any other limiting criteria that is explicit, implicit, or inherent to the presentation of an advertisement.

The presentation module 230 is configured to present selected advertisements, for instance, at a user interface associated with the user device 212. In one aspect of the invention, presentation may comprise displaying a graphical representation of the advertisement (e.g., icon, a pictogram, a symbol, alphanumeric character(s), bitmapped graphics, or the like) as received from the advertiser. In another aspect of the invention, presentation may comprise an audio signal (e.g., sounds consistent with a commercial emitted from a computing device). However, it will be understood and appreciated by those of ordinary skill in the art that methods for presenting an advertisement are not limited to the embodiments described herein and that presentation may vary accordingly.

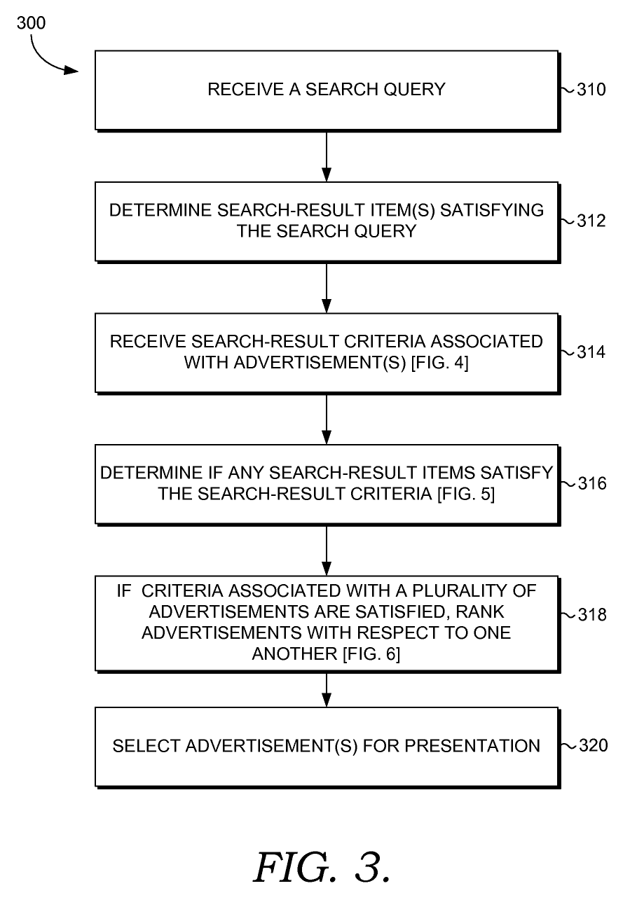

Turning now to FIG. 3, a flow diagram is illustrated that shows a method 300 for selecting advertisements for presentation, in accordance with an embodiment of the present invention. Initially, as indicated at block 310, a search query is received, for instance, by search module 218 of FIG. 2. Search-result item(s) satisfying the search query are subsequently determined, as indicated at block 312. Next, as indicated at block 314, at least one search-result criterion associated with an advertisement is received, e.g., utilizing advertisement module 220 of FIG. 2. As discussed in more detail above, the search-result criterion is used to select advertisements for presentation and may include positional criteria.

Subsequently, it is determined if any search-result items that were determined to satisfy the search query also satisfy the received search-result criterion. This is indicated at block 316. If search-result criteria associated with a plurality of advertisements are satisfied, the advertisements are ranked with respect to one another (e.g., utilizing advertisement ranking module 228 of FIG. 2), as indicated at block 318. Subsequently, as indicated at block 320, selected advertisements determined to have a favorable ranking are selected for presentation, e.g., utilizing presentation module 230 of FIG. 2.

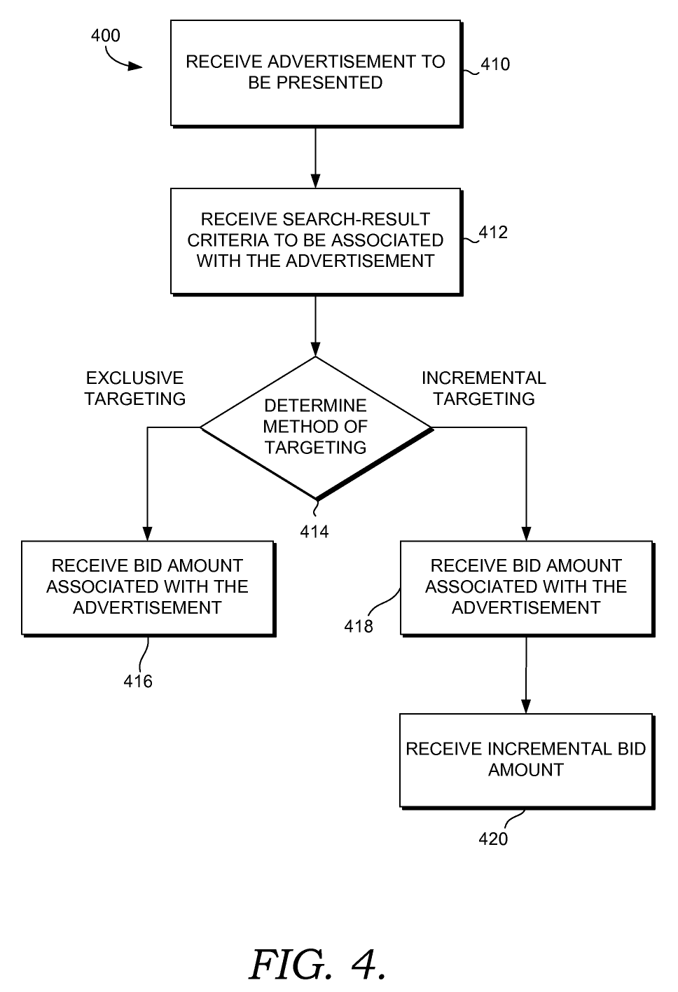

With reference to FIG. 4, a flow diagram is illustrated that shows a method 400 for receiving a search-result criterion, e.g., utilizing advertisement module 220, in accordance with an embodiment of the present invention. Initially, as indicated at block 410, an advertisement to be presented is received, e.g., by an advertiser accessing an appropriate user interface. Next, as indicated at block 412, one or more search-result criterion to be associated with the advertisement is received.

Next, it is determined whether and what method of targeting is desired, as indicated at block 414. If the method of exclusive targeting is determined, a bid amount associated with the advertisement may be provided, as indicated at block 416. If, however, the method of incremental targeting is determined, the bid amount associated with the advertisement may be received, as indicated at block 418, and the amount of the incremental bid, as indicated at block 420.

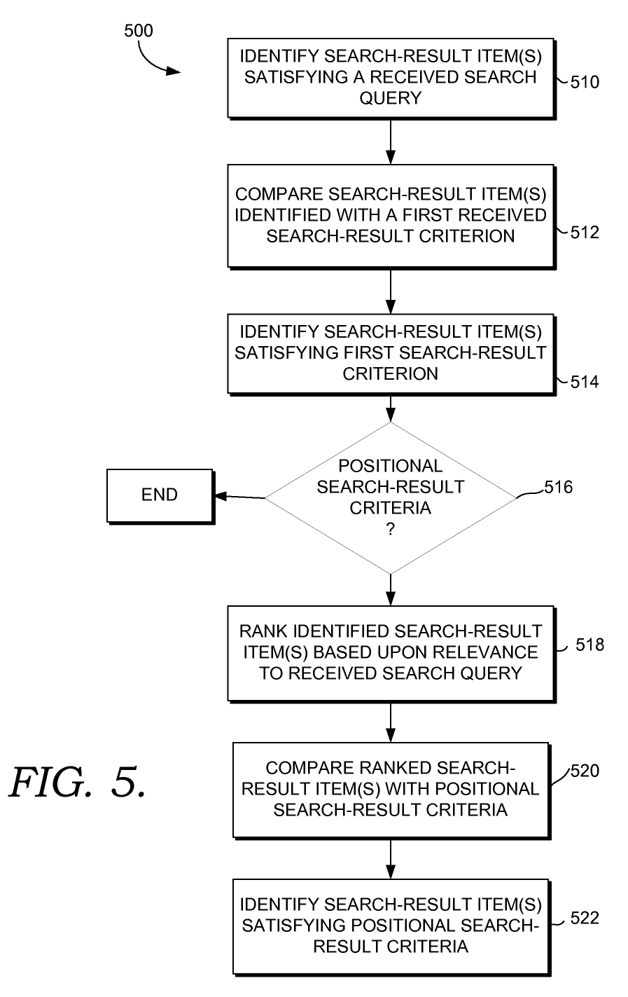

Turning now to FIG. 5, a flow diagram is illustrated that shows a method 500 for determining if any search-result items satisfy received search-result criteria, in accordance with an embodiment of the present invention. Initially, search-result item(s) satisfying a received search query are identified, as indicated at block 510. Next, as indicated at block 512, the search-result item(s) identified are compared with a first received search-result criterion (e.g., a URL with which the associated advertiser either does or does not desire to be associated). Next, as indicated at block 514, search-result items satisfying the first search-result criterion are identified.

Subsequently, as indicated at block 516, it is determined whether one or more positional search-result criteria have been received. If it is determined that no positional search-result criteria have been received, the method ends. If, however, it is determined that at least one positional search-result criterion has been received, the identified search-result items are ranked with respect to one another based upon relevance to the received search query. This is indicated at block 518. Next, the ranked search-result items are compared with the positional search-result criteria, as indicated at block 520, and those search-result item(s) satisfying the positional search-result criterion are identified. This is indicated at block 522.

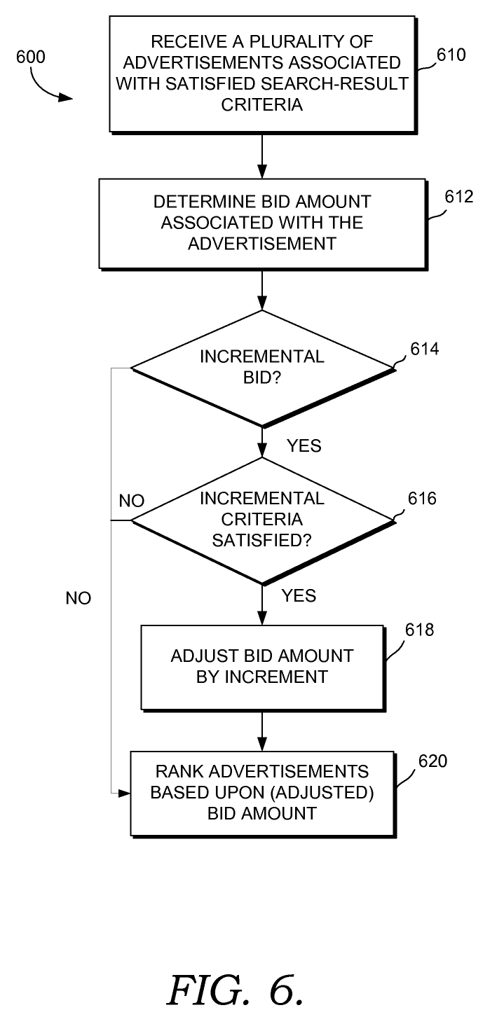

Turning now to FIG. 6, a flow diagram showing a method 600 for ranking advertisements, e.g., utilizing advertisement ranking module 228 of FIG. 2, in accordance with an embodiment of the present invention, is shown. Initially, as indicated at block 610, a plurality of advertisements associated with satisfied search-result criteria is received. Next, as indicated at block 612, a bid amount associated with each of the plurality of advertisements is determined. Once the bid amount is determined, it is determined if an incremental bid is desired. This is indicated at block 614. If an incremental bid is not desired, the advertisements are ranked relative to one another based upon the amount bid therefore. This is indicated at block 620. If, however, an incremental bid is desired, it is subsequently determined if the incremental criteria associated with the incremental bid is satisfied. This is indicated at block 616.

If it is determined that the incremental criteria associated with the incremental bid is not satisfied, the advertisements are ranked relative to one another based upon the amount bid therefore, as indicated at block 620. If, however, it is determined that the incremental criteria is satisfied, the bid amount is adjusted by the specified increment, as indicated at block 618. Subsequently, as indicated at block 620, the advertisements are ranked relative to one another based upon the adjusted bid amounts.

As can be seen from the above, embodiments of the present invention provide computerized methods and systems for selecting advertisements for presentation based, at least in part, upon search-result items. Upon receiving a search query, search-result items (for instance, uniform resource locators (URLs)) satisfying the search query are determined. The determined search-result items are then compared with search-result criteria associated with advertisements to determine if the search-result criteria are satisfied. Search result criteria may include, by way of example only, a particular URL an advertiser either does or does not desire to be presented in association with, ranking or position of a particular URL relative to other search-result items, and the like. The determination whether or not the search-result criteria associated with an advertisement is satisfied is then utilized to determine whether the advertisement is selected for presentation in association with the search-result items. Advertisements selected for presentation may be ranked relative to one another based upon a bid amount associated therewith, with only a pre-determined number of advertisements ultimately being displayed in association with the search-result items.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

What is claimed is:

1. One or more computer-readable media having computer-executable instructions embodied thereon that, when executed, perform a method for selecting advertisements for presentation based upon search-result items, the method comprising:
receiving a search query;
determining at least one search-result item that satisfies the search query;
receiving a first search-result criterion associated with an advertisement; and
determining if the at least one search-result item satisfies the first search-result criterion.

2. The one or more computer-readable media of claim 1, wherein receiving the first search-result criterion associated with the advertisement comprises receiving a uniform resource locator (URL) in association with which the associated advertisement is to be presented, and wherein determining if the at least one search-result item satisfies the first search-result criterion comprises determining if the at least one search-result item includes the URL.

3. The one or more computer-readable media of claim 1, wherein if it is determined that the at least one search-result item satisfies the first search-result criterion, the method further comprises selecting the advertisement associated with the first search-result criterion for presentation in association with the at least one search-result item.

4. The one or more computer-readable media of claim 1, wherein receiving the first search-result criterion associated with the advertisement comprises receiving a uniform resource locator (URL) in association with which the associated advertisement is not to be presented, and wherein determining if the at least one search-result item satisfies the first search-result criterion comprises determining if the at least one search-result item includes the URL.

5. The one or more computer-readable media of claim 1, wherein if it is determined that the at least one search-result item satisfies the first search-result criterion, the method further comprises excluding the advertisement associated with the first search-result criterion from presentation in association with the at least one search-result item.

6. The one or more computer-readable media of claim 1, wherein determining the at least one search-result item that satisfies the search query comprises determining a plurality of search-result items that satisfy the search query, and wherein the method further comprises receiving a second search-result criterion associated with the advertisement that includes positional criteria pertaining to a position of the at least one search-result item relative to other search-result items comprising the plurality of search-result items.

7. The one or more computer-readable media of claim 6, wherein the method further comprises:
algorithmically ranking the plurality of search-result items; and
determining if the at least one search-result item satisfies the second search-result criterion.

8. The one or more computer-readable media of claim 1, further comprising determining if the advertisement is relevant to the received search query prior to determining if the at least one search-result item satisfies the first search-result criterion associated with the advertisement.

9. The one or more computer-readable media of claim 1, further comprising:
identifying a plurality of advertisements associated with search-result criteria that are satisfied by the at least one search-result item; and
ranking the identified plurality of advertisements with respect to one another utilizing an amount bid therefore.

10. A computer system for selecting advertisements for presentation based upon search-result items, the system comprising:
a search module configured to receive a search query and to determine one or more search-result items that satisfy the received search query;
an advertisement module configured to receive one or more search-result criterion, each search-result criterion having an advertisement associated therewith, and configured to receive a bid amount associated with each advertisement; and
a determining module configured to determine if one or more received search-result items satisfies at least one of the one or more received search-result criterion.

11. The computer system of claim 10, further comprising a search-result item ranking module configured to rank a plurality of received search-result items with respect to one another based upon relevance to the received search query.

12. The computer system of claim 11, further comprising a selection module configured to select or exclude advertisements associated with the one or more search-result criterion for presentation based upon whether the one or more search-result items that satisfy the received search query are determined to satisfy at least one of the one or more search-result criterion.

13. The computer system of claim 12, further comprising an advertisement ranking module configured to rank a plurality of selected advertisements with respect to one another based upon the bid amount associated therewith.

14. The computer system of claim 13, further comprising a presentation module configured to present selected advertisements.

15. A computerized method for associating advertisements with search-result criteria, the method comprising:
receiving an advertisement;
receiving at least one search-result criterion, the at least one search-result criterion providing a characteristic to be satisfied by one or more search-result items before the one or more search-result items are selected for or excluded from presentation in response to a search query; and
storing the advertisement and the at least one search-result criterion in association with one another.

16. The computerized method of claim 15, wherein receiving the at least one search-result criterion comprises receiving an attribute related to one or more web pages.

17. The computerized method of claim 15, further comprising:
receiving a search query;
determining the one or more search-result items that satisfy the search query; and
determining if the one or more search-result items include the attribute related to one or more web pages.

18. The computerized method of claim 17, wherein if it is determined that the at least one search-result item includes the attribute related to one or more web pages, the method further comprises selecting the advertisement associated with the at least one search-result criterion for presentation.

19. The computerized method of claim 17, wherein if it is determined that the at least one search-result item includes the attribute related to one or more web pages, the method further comprises excluding the advertisement associated with the at least one search-result criterion from presentation.

20. The computerized method of claim 17, wherein determining the one or more search-result items that satisfies the search query comprises determining a plurality of search-result items that satisfy the search query, and wherein receiving at least one search-result criterion comprises receiving positional criteria pertaining to a position of the one or more search-result items relative to other search-result items comprising the plurality of search-result items.
